(19) United States
(12) Patent Application Publication
(10) Pub. No.: US 2010/0018092 A1
(43) Pub. Date: Jan. 28, 2010

(54) PHOTOLUMINESCENT EXIT SIGNS AND METHODS FOR FORMING SAME

(76) Inventor: Geoffrey M. PECKHAM, Milford, PA (US)

Correspondence Address: HESLIN ROTHENBERG FARLEY & MESITI PC, 5 COLUMBIA CIRCLE, ALBANY, NY, 12203, US

(21) Appl. No.: 12/508,071

(22) Filed: Jul. 23, 2009

Related U.S. Application Data
(60) Provisional application No. 61/083,037, filed on Jul. 23, 2008.

(51) Int. Cl. G09F 13/20; H01J 9/00

(52) U.S. Cl. 40/542; 445/22

(57) ABSTRACT

A photoluminescent EXIT sign includes a generally planar faceplate comprising a plurality of openings defining the word “EXIT” and optional chevrons. At least some of the periphery of said openings comprises an angle relative to the surface of the faceplate. A backplate has a photoluminescent material and is disposed adjacent to the faceplate so as to result in the illuminated letters defining the work “EXIT” and optional chevrons. Methods for forming photoluminescent EXIT signs are also disclosed.

### CLAIM TO PRIORITY

This application claims the benefit of U.S. Provisional Application No. 61/083,037, filed Jul. 23, 2009, entitled “Photoluminescent Exit Sign,” the entire subject matter of which is hereby incorporated herein by reference.

### FIELD OF THE INVENTION

This invention relates generally to photoluminescent EXIT signs, and more particularly to photoluminescent EXIT signs and methods for forming photoluminescent EXIT signs.

### BACKGROUND OF THE INVENTION

Photoluminescent EXIT signs have been around for nearly a decade.

One example of a photoluminescent EXIT signs includes printing the word “EXIT” and the chevrons (arrow indicating either a right direction, a left direction, or both left and right directions) using a non-photoluminescent material such as an opaque ink onto a sheet of photoluminescent material disposed on a plastic material or coated metal material.

In another example, a negative configuration of the example above, includes providing a sheet of photoluminescent material disposed on a plastic material or coated metal material, and applying an opaque layer on all but the word “EXIT” and the chevrons thereby leaving only the text and chevrons displaying the photoluminescent material.

In a further example, a sheet of photoluminescent material is placed inside a metal box having a cover or front surface with the word “EXIT” and chevrons cut out. In particular, the sheet of photoluminescent material is placed up against the cover.

Currently, the photoluminescent material is applied to plastics, or sold as paint for other applications. Green, red, and black offsetting non-photoluminescent colors are sold today and used for the EXIT sign described above. For example, a Glo Brite Photo-Luminescent Exit Signs are manufactured by or available from Seton of Branford, Conn.

There is a need for further photoluminescent EXIT signs and methods for forming photoluminescent EXIT signs.

### SUMMARY OF THE INVENTION

In a first aspect, the present invention is directed to a photoluminescent EXIT sign that includes a generally planar rectangular metallic faceplate comprising a front surface, a rear surface, a length, and a width. The faceplate includes a plurality of openings through the faceplate extending from the front surface to the rear surface defining the word “EXIT.” A periphery of the each of the openings includes a metallic beveled surface extending between the front surface and the rear surface of the faceplate. A colored layer is disposed on the front surface of the faceplate. A generally planar photoluminescent backplate includes a front surface and a rear surface. The front surface of the backplate is disposed tightly against the rear surface of the faceplate so that the lowermost edges of the openings defining the word “EXIT” are disposed tightly against the front surface of the generally planar photoluminescent backplate. The beveled surfaces along the peripheral edge of the openings defining the word “EXIT” being operable to reflect ambient light in lighted conditions and reflect luminescent light emitted from the photoluminescent backplate in dark conditions.

In a second aspect, the present invention is directed to a method for forming a photoluminescent EXIT sign. The method includes providing a generally planar rectangular metallic faceplate, forming a plurality of openings defining the word “EXIT,” a periphery of the each of the openings comprising a metallic beveled surface extending between the front surface and the rear surface of the faceplate, providing a backplate comprising a photoluminescent material, and disposing the photoluminescent material of the backplate adjacent to the faceplate to result in illuminated letters defining the word “EXIT.”

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and the accompanying drawings in which:

FIG. 1 is a perspective view of one embodiment of a photoluminescent EXIT sign in accordance with the present invention;

FIG. 2 is an enlarged cross-sectional view taken along lines 2-2 in FIG. 1;

FIG. 3 is an enlarged cross-sectional view taken along lines 3-3 in FIG. 1;

FIG. 4 is an enlarged front view of a portion of the photoluminescent EXIT sign of FIG. 1 illustrating the contrast between the front surface and the cutout of the right chevron;

FIG. 5 is a perspective view of another embodiment of a photoluminescent EXIT sign in accordance with the present invention;

FIG. 6 is an enlarged cross-sectional view taken along lines 6-6 in FIG. 5;

FIG. 7 is an enlarged cross-sectional view taken along lines 7-7 in FIG. 5;

FIG. 8 is an enlarged front view of a portion of the photoluminescent EXIT sign of FIG. 5 illustrating the contrast between the front surface and the cutout of the right chevron;

FIG. 9 is a perspective view of another embodiment of a photoluminescent EXIT sign in accordance with the present invention;

FIG. 10 is an enlarged cross-sectional view taken along lines 10-10 in FIG. 9;

FIG. 11 is an enlarged cross sectional view taken along lines 10-10 in FIG. 9;

FIG. 12 is a perspective view of another embodiment of a photoluminescent EXIT sign in accordance with the present invention;

FIG. 13 is an enlarged cross-sectional view taken along lines 13-13 in FIG. 12; and

FIG. 14 is an enlarged cross-sectional view taken along lines 14-14 in FIG. 12.

### DETAILED DESCRIPTION OF THE INVENTION

In one aspect, the present invention is directed to improve highly visible architecturally pleasing photoluminescent EXIT signs. This non-electrical EXIT sign's purpose is to guide people to exits in both normal and emergency conditions. The use of a photoluminescent back panel enables the sign to be seen when loss of power occurs.

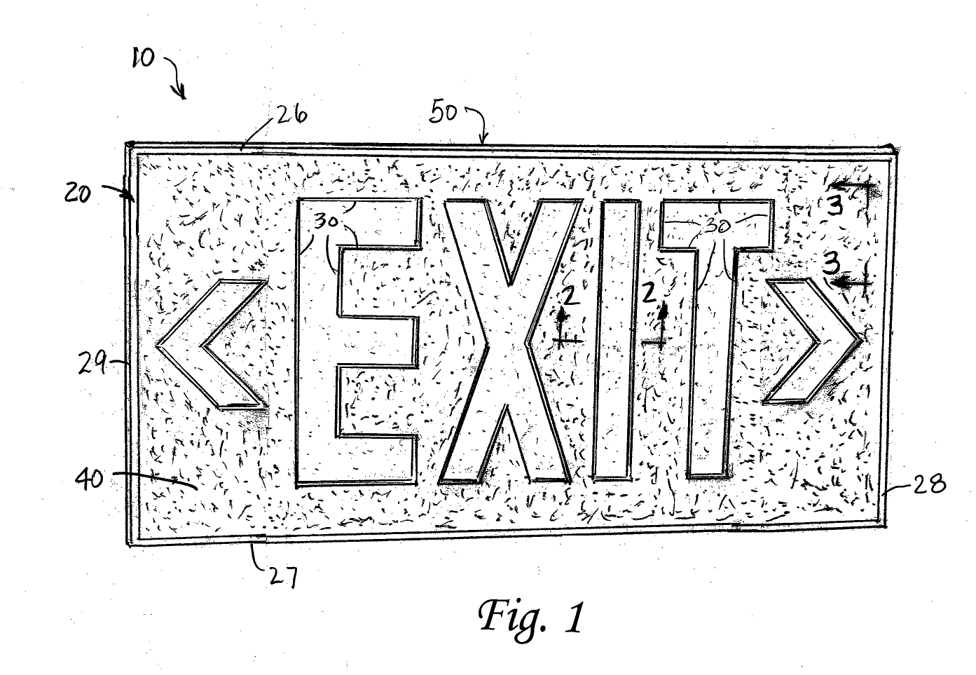

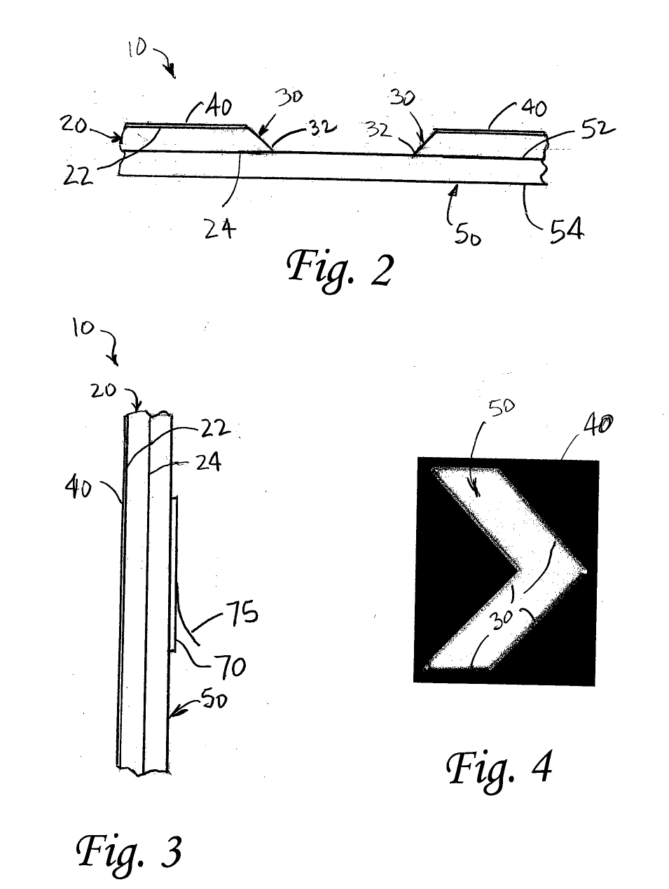

FIGS. 1-3 illustrate one embodiment of a photoluminescent EXIT sign 10 in accordance with the present invention, which generally includes two component parts. Photoluminescent EXIT sign 10 may include a faceplate 20 with a plurality of cutouts having beveled edges or angled surface openings defining the word “EXIT” and optional chevrons, and a photoluminescent backplate 50 (best shown in FIGS. 2 and 3).

For example, faceplate 20 may be a planar member such as an elongated planer member, e.g., a rectangular planar member, having a front side 22 (FIGS. 2 and 3), a rear side 24 (FIGS. 2 and 3), a top edge 26, a bottom edge 27, a right side edge 28, and a left side edge 29. Faceplate 20 may be formed from a metallic material such as an aluminum plate in which the cutouts are milled or formed with a plurality of peripherally-extending angled or beveled edges 30 (FIGS. 1 and 3) that exposes the bright natural or bare metallic material around the edge of the letters.

Faceplate 20 may further include a colored coating 40 such as a dark solid color coating disposed on front surface 22. The solid colored surface may be a red or black polymer or anodized coating. The contrast between the front coated surface of the faceplate and the cutouts is best illustrated in FIG. 4 which shows a portion of the faceplate having a dark black color which surrounds the right chevron cutouts through which light may be emitted therethrough from the photoluminescent backplate 50.

As best shown in FIGS. 1 and 2, in faceplate 20, the periphery of each of the openings defining the letters and each of the directional chevrons may be defined by a beveled edge 30. For example, beveled edges 30 may extend around the entire periphery of each of the letters and each of the directional chevrons. In addition, the beveled edges may extend from front surface 22 to rear surface 24. The beveled edges may further be disposed on an angle of about 45-degree relative to front surface 22 of faceplate 20. For example, faceplate 20 may have a thickness of about 1/16-inch. The cutouts or openings may be formed with a machining tool that produces a beveled edge of about 45-degrees relative to the front surface and extending from the front surface to the rear surface resulting in an exposed beveled surface about 1.5 mm wide.

Backplate 50 may comprise a photoluminescent impregnated polymer sheet such as a photoluminescent impregnated thermoplastic polymer sheet, e.g., a photoluminescent impregnated polymer PVC (polyvinylchloride) sheet. Backplate 50 includes a front surface 52 and a rear surface 54, and may have a length and width which corresponds to the length and width of the faceplate. Front surface 52 of backplate 50 is abutted and disposed tightly against rear surface 54 of faceplate 20 so that lowermost edges 32 (FIG. 2) of beveled edges 30 rests on the front surface of backplate 50. For example, front surface 52 may be adhesively bonded to rear surface 24 of faceplate 20. The photoluminescent impregnated polymer sheet desirably has a luminance of at least about 50 mcd/m2 at 60 minutes after exposure to 1000 lux xenon arc lamp for 5 minutes. A suitable photoluminescent impregnated polymer sheet is available from Jalite USA of Milford, Pa., model number JLUME.

The rear surface of the backplate is typically disposed against a wall or other surface such as above a door or doorway. For example, when photoluminescent EXIT sign 10 is installed in a desired location, an installer may attach the rear surface to the wall using a suitable adhesive or bonding agent which is applied between the rear surface of the backplate and the wall. Alternatively, one or more adhesive materials may be disposed on the rear surface of the backplate. For example, as shown in FIG. 3, one or more adhesive strips 70 having a release sheet 75 may be disposed on the rear surface of the backplate. Alternatively, an optional frame may be used to secure the photoluminescent EXIT sign to the wall or the EXIT sign may be operably supported to hang from the ceiling.

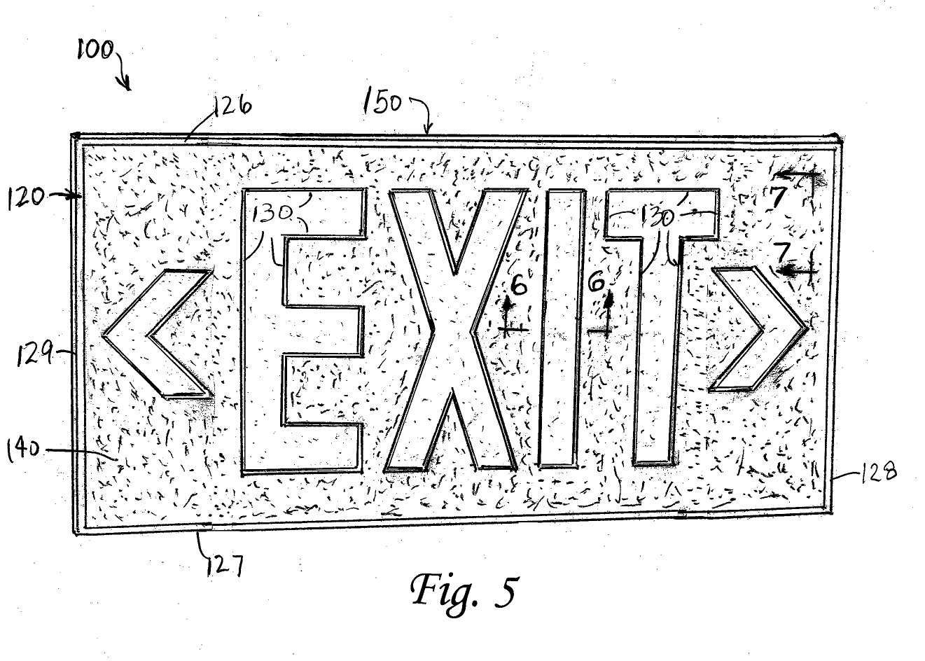

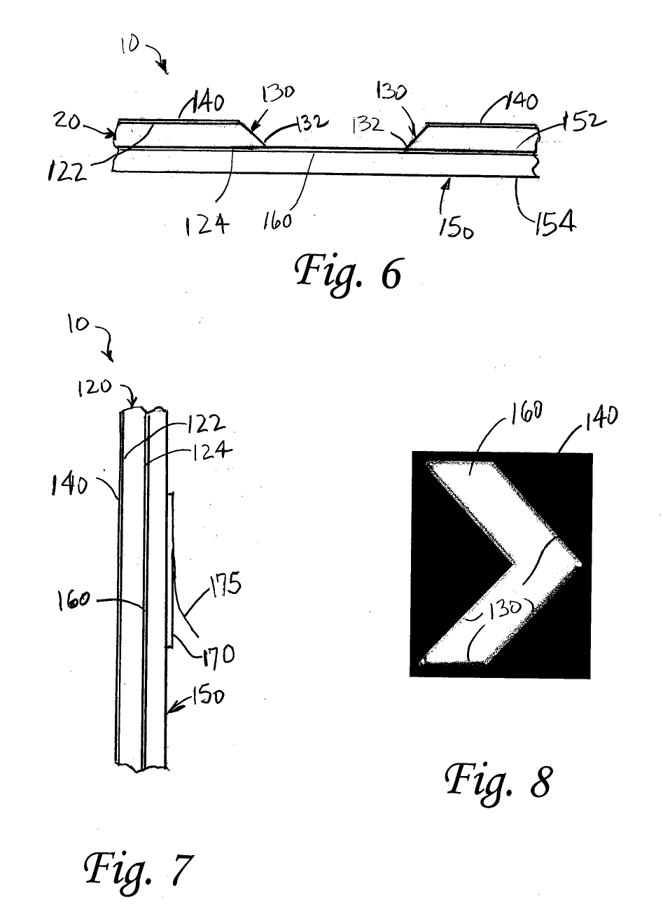

FIGS. 5-7 illustrate another embodiment of a photoluminescent EXIT sign 100 in accordance with the present invention, which generally includes three component parts. Photoluminescent EXIT sign 100 may include a faceplate 120 with a plurality of cutouts having beveled edges or angled surface openings defining the word “EXIT” and optional chevron(s), a backplate 150, and a photoluminescent layer 160 (best shown in FIGS. 6 and 7).

For example, faceplate 120 may be a planar member such as an elongated planer member, e.g., a rectangular planar member, having a front side 122 (FIGS. 6 and 7), a rear side 124 (FIGS. 2 and 3), a top edge 126, a bottom edge 127, a right side edge 128, and a left side edge 129. Faceplate 120 may be formed from a metallic material such as an aluminum plate in which the cutouts are milled or formed with a plurality of peripherally-extending angled or beveled edges 130 (FIGS. 5 and 6) that expose the bright natural or bare metallic material around the edge of the letters.

Faceplate 120 may further include a colored coating 140 such as a dark solid color coating disposed on front surface 122. For example, the solid colored surface may be a suitable red or black polymer or anodized coating. The contrast between the front coated surface of the faceplate and the cutouts is best illustrated in FIG. 8 which is shows a portion of the faceplate having a dark black color which surrounds the right chevron cutout through which light may be emitted therethrough from the photoluminescent layer 160.

As best shown in FIGS. 5 and 6, in faceplate 120, the periphery of each of the openings defining the letters and each of the directional chevrons may be defined by beveled edge 130. For example, beveled edges 130 may extend around the entire periphery of each of the letters and each of the directional chevrons. In addition, the beveled edges may extend from front surface 122 to rear surface 124. The beveled edges may further be disposed on an angle of about 45-degree relative to front surface 122 of faceplate 120. For example, faceplate 120 may have a thickness of about 1/16-inch. The cutouts or openings may be formed with a machining tool that produces a beveled edge of about 45-degrees relative to the front surface and extending from the front surface to the rear surface resulting in an exposed beveled surface about 1.5 mm wide.

Backplate 150 may comprise a metal or plastic planar layer such as formed from a PVC plastic or aluminum material. Photoluminescent layer 160 may be a sheet of photoluminescent material or a photoluminescent coating. For example, backplate 150 and photoluminescent layer 160 may be a photoluminescent lacquer-coated aluminum plate.

Backplate 150 includes a front surface 152 and a rear surface 154, and may have a length and width which corresponds to the length and width of the faceplate. Photoluminescent layer 160 is disposed on backplate 150. A front surface of photoluminescent layer 160 is abutted and disposed tightly against rear surface 124 of faceplate 120 so that lowermost edges 132 (FIG. 6) of beveled edges 130 rests on the front surface of photoluminescent layer 160. For example, rear surface of the faceplate may be adhesively bonded to front surface of photoluminescent layer 160. Photoluminescent layer 160 desirably has a luminance of at least about 50 mcd/m2 at 60 minutes after exposure to 1000 lux xenon arc lamp for 5 minutes. A suitable photoluminescent impregnated polymer sheet is available from Jalite USA of Milford, Pa., model number JLUME.

The rear surface of the backplate is typically disposed against a wall or other surface such as above a door or doorway. For example, when photoluminescent EXIT sign 100 is installed in a desired location, an installer may attach the rear surface to the wall using a suitable adhesive or bonding agent which is applied between the rear surface of the backplate and the mounting surface. Alternatively, one or more adhesive materials may be disposed on the rear surface of the backplate. For example, as shown in FIG. 7, one or more adhesive strips 170 having a release sheet 175 may be disposed on the rear surface of the backplate.

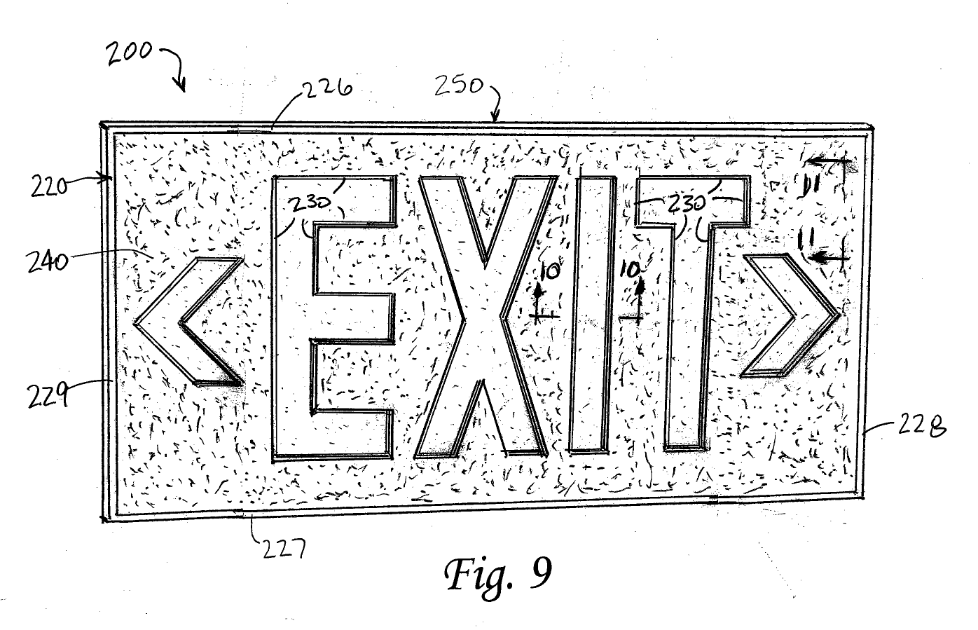

FIGS. 9-11 illustrate another embodiment of a photoluminescent EXIT sign 200 in accordance with the present invention, which generally includes two component parts. Photoluminescent EXIT sign 200 may include a faceplate 220 with a plurality of beveled cutouts or angled surface openings defining the word “EXIT” and optional chevrons, and a backplate 250 of photoluminescent material.

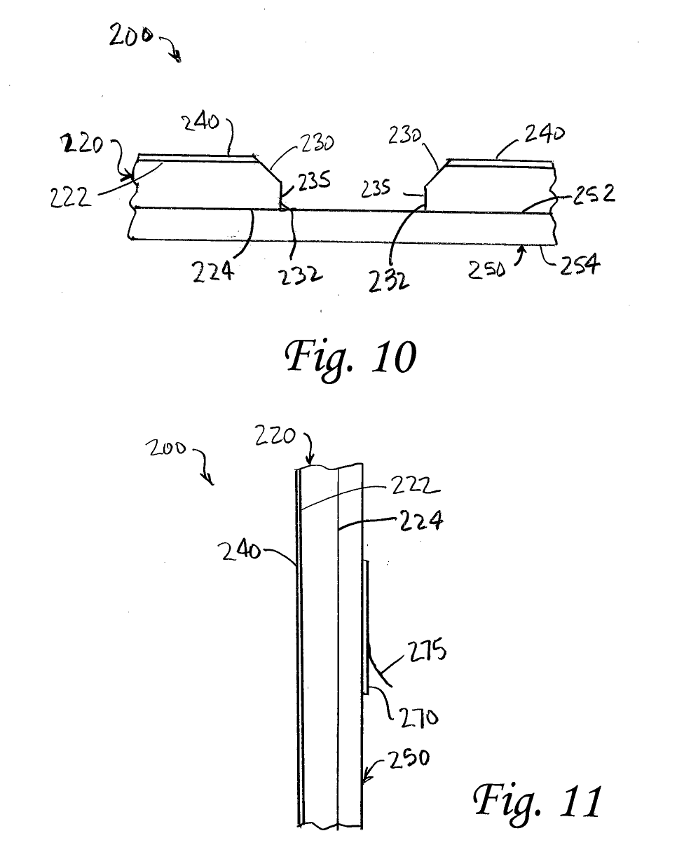

For example, faceplate 220 may be a planar member such as an elongated planer member, e.g., a rectangular planar member, having a front side 222, a rear side 224 (FIGS. 10 and 11), a top edge 226, a bottom edge 227, a right side edge 228, and a left side edge 229. Faceplate 220 may be formed from a metallic material such as an aluminum plate in which the cutouts are milled or formed with a peripherally-extending angled or beveled edge that exposes the bright natural metallic material around the edge of the letters and optional chevrons.

Faceplate 220 may further include a colored coating 240 such as a dark solid color coating disposed on front surface 222. The solid colored surface may be a red or black polymer or anodized coating. The contrast between the front coated surface of the faceplate and the cutouts may be similar to that shown in FIGS. 4 and 8.

As best shown in FIGS. 9 and 10, in faceplate 220, the periphery of each of the openings defining the letters and each of the directional chevrons may be defined by a beveled edge 230. For example, beveled edges 230 may extend around the entire periphery of each of the letters and each of the directional chevrons. In addition, the beveled edges may extend between front surface 222 and rear surface 224. The beveled edges may further be disposed on an angle of about 45-degree relative to front surface 222 of faceplate 220. For example, faceplate 220 may be about ⅛-inch in thickness. The cutouts or openings may be formed with a machining tool that produces a beveled edge of 45-degrees relative to the front surface and extending from the front surface to about the middle of the faceplate, e.g., half of the cut ( 1/16-inch depth). A straight or normal edge 235 disposed at 90-degrees relative to the front or rear surface of the faceplate extends from the beveled edge to the rear surface for the remaining half of the cut ( 1/16-inch depth).

Backplate 250 may comprise a photoluminescent impregnated polymer sheet such as a photoluminescent impregnated thermoplastic polymer sheet, e.g., a photoluminescent impregnated polymer PVC (polyvinylchloride) sheet. Backplate 250 includes a front surface 252 and a rear surface 254, and may have a length and width which corresponds to the length and width of the faceplate. Front surface 252 of backing plate 250 is abutted and disposed tightly against rear surface 224 of faceplate 220 so that lowermost edges 232 (FIG. 10) of normal edges 235 rests on the front surface of backplate 250. For example, front surface 252 may be adhesively bonded to rear surface 224 of faceplate 250. The photoluminescent impregnated polymer sheet desirably has a luminance of at least about 50 mcd/m2 at 60 minutes after exposure to 1000 lux xenon arc lamp for 5 minutes. A suitable photoluminescent impregnated polymer sheet is available from Jalite USA of Milford, Pa., model number JLUME.

The rear surface of the backplate is typically disposed against a wall or other surface such as above a door or doorway. For example, when photoluminescent EXIT sign 200 is installed in a desired location, an installer may attach the rear surface to the wall using a suitable adhesive or bonding agent which is applied between the rear surface of the backplate. Alternatively, one or more adhesive materials may be disposed on the rear surface of the backplate. For example, as shown in FIG. 11, one or more adhesive strips 270 having a release sheet 275 may be disposed on the rear surface of the backplate. Alternatively, an optional frame may be used to secure the photoluminescent EXIT sign to the wall or the EXIT sign may be operably supported to hang from the ceiling.

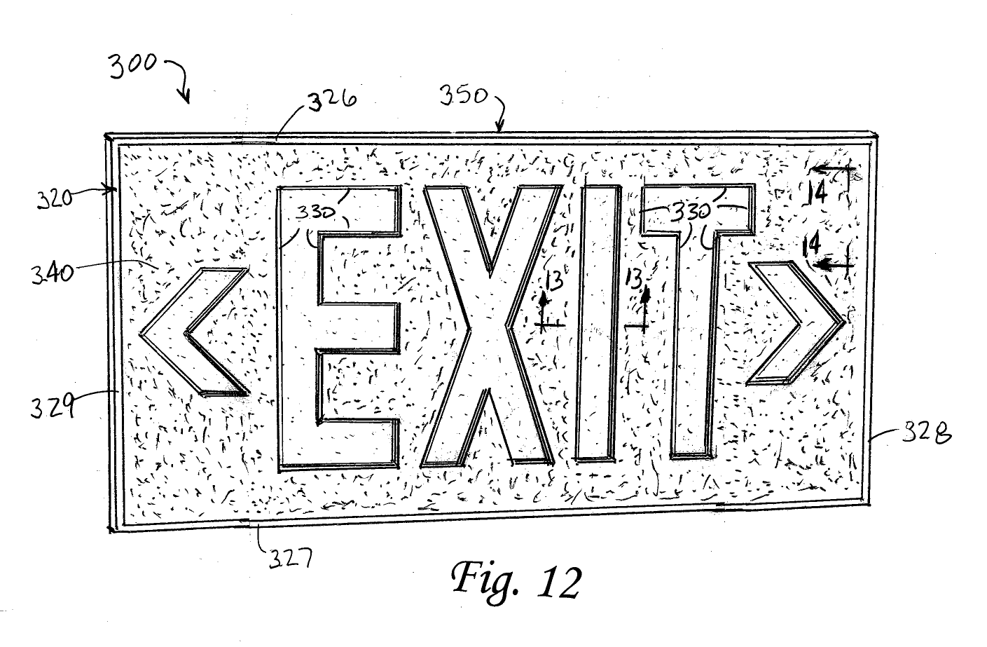

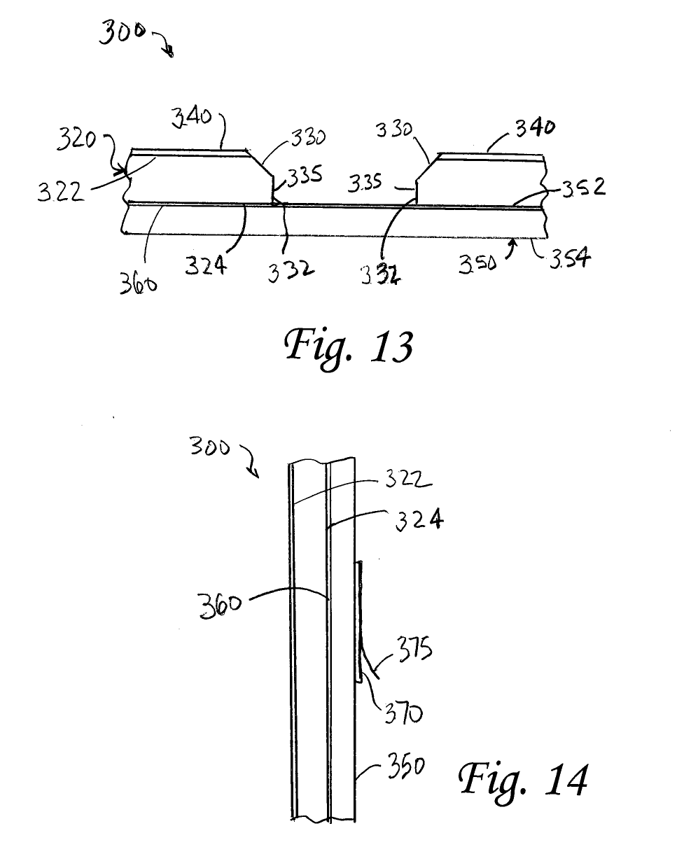

FIGS. 12-14 illustrate another embodiment of a photoluminescent EXIT sign 300 in accordance with the present invention, which generally includes three component parts. Photoluminescent EXIT sign 300 may include a faceplate 320 with a plurality of cutouts having beveled edges or angled surface openings defining the word “EXIT” and optional chevrons, and a backplate 350 and photoluminescent layer 360 (best shown in FIGS. 13 and 14).

For example, faceplate 320 may be a planar member such as an elongated planer member, e.g., a rectangular planar member, having a front side 322 (FIGS. 13 and 14), a rear side 324 (FIGS. 13 and 14), a top edge 326, a bottom edge 327, a right side edge 328, and a left side edge 329.

Faceplate 320 may be formed from a metallic material such as an aluminum plate in which the cutouts are milled or formed with a plurality of peripherally-extending angled or beveled edges 330 (FIGS. 5 and 6) that exposes the bright natural or bare metallic material around the edge of the letters. Faceplate 320 may be formed from a metallic material such as an aluminum plate in which the cutouts are milled or formed with a peripherally-extending angled or beveled edge that exposes the bright natural metallic material around the edge of the letters and optional chevrons.

Faceplate 320 may further include a colored coating 340 such as a dark solid color coating disposed on front surface 322. For example, the solid colored surface may be a suitable red or black polymer or anodized coating. The contrast between the front coated surface of the faceplate and the cutouts may be similar to that shown in FIGS. 4 and 8.

As best shown in FIG. 13, in faceplate 320, the periphery of each of the openings defining the letters and each of the directional chevrons may be defined by beveled edge 330. For example, beveled edges 330 may extend around the entire periphery of each of the letters and each of the directional chevrons. In addition, the beveled edges may extend between front surface 322 and rear surface 324. The beveled edges may further be disposed on an angle of about 45-degree from front surface 322 of faceplate 320. For example, faceplate 320 may be about ⅛-inch in thickness. The cutouts or openings may be formed with a machining tool that produces beveled edge 330 of 45-degrees relative to the front surface and extending from the top surface to about the middle of the faceplate, e.g., half of the cut ( 1/16-inch depth). A straight or normal edge 335 disposed at 90-degrees relative to the front or rear surface of the faceplate extends from the beveled edge to the rear surface for the remaining half of the cut ( 1/16-inch depth).

Backplate 350 may comprise a metal or plastic planar layer such as formed from a PVC plastic or aluminum material. Photoluminescent layer 360 may be a sheet of photoluminescent material or a photoluminescent coating. For example, backplate 350 and photoluminescent layer 360 may be a photoluminescent lacquer-coated aluminum plate.

Backplate 350 includes a front surface 352 and a rear surface 354, and may have a length and width which corresponds to the length and width of the faceplate. Photoluminescent layer 360 is disposed on backplate 350. A front surface of photoluminescent layer 360 is abutted and disposed tightly against rear surface 324 of faceplate 320 so that lowermost edges 332 (FIG. 13) of edge 335 rests on the front surface of photoluminescent layer 360. For example, rear surface of the faceplate may be adhesively bonded to front surface of photoluminescent layer 360. Photoluminescent layer 360 desirably has a luminance of at least about 50 mcd/m2 at 60 minutes after exposure to 1000 lux xenon arc lamp for 5 minutes. A suitable photoluminescent impregnated polymer sheet is available from Jalite USA of Milford, Pa., model number JLUME.

The rear surface of the backplate is typically disposed against a wall or other surface such as above a door or doorway. For example, when photoluminescent EXIT sign 300 is installed in a desired location, an installer may attach the rear surface to the wall using a suitable adhesive or bonding agent which is applied between the rear surface of the backplate. Alternatively, one or more adhesive materials may be disposed on the rear surface of the backplate. For example, as shown in FIG. 14, one or more adhesive strips 370 having a release sheet 375 may be disposed on the rear surface of the backplate. Alternatively, an optional frame may be used to secure the photoluminescent EXIT sign to the wall or the EXIT sign may be operably supported to hang from the ceiling.

The exposed metallic material around the peripheral edges of the cutout letters defining the word “EXIT” and optional chevrons creates contrast between the design and the anodized black or red color of the faceplate as well as heightened contrast between the photoluminescent material and the faceplate increasing visibility and conspicuity under normal lighting.

In visibility tests of the embodiment described with reference to FIGS. 1-4, the photoluminescent EXIT sign, performed by Underwriter's Laboratory (UL), the beveled natural aluminum edge of the sign functioned to increase the visibility of the EXIT sign's directional chevron indicator. In the completely dark test conditions stipulated by UL, the EXIT sign's beveled metal edge reflected the luminance of the photoluminescent material and the test participants could easily describe the indicated direction of travel indicated by the EXIT sign's chevron at the required 40 feet viewing distance. Chevrons made from material having the same luminance properties as the EXIT sign's photoluminescent backing plate and having similar and even slightly larger sizes, were not able to have their direction differentiated by the test participants at the required 40 feet viewing distance when a beveled edge faceplate was not used. Thus, the aesthetic design enhancement of the beveled edge gives an attractive depth dimension to a photoluminescent EXIT sign in light conditions, and has also become a distinctive technical differentiator, giving the EXIT sign higher visibility in dark conditions.

From the present description, photoluminescent EXIT signs in accordance with the present invention may have one, two, or no directional chevrons resulting in four different designs, e.g., EXIT signs with right pointing chevron, EXIT signs with left pointing chevron, EXIT signs with both left and right pointing chevrons, and EXIT signs with no chevrons.

The 1/16-inch and ⅛-inch thick architectural grade aluminum material also exhibits a significantly improved aesthetic design when compared to other existing photoluminescent EXIT signs giving it greater appeal for use by those designing the interior space of high-end buildings. In addition, the EXIT signs may be readily attached to a wall such as above a door with adhesive, suitable fasteners or optional frame.

While the above description of the invention is directed to EXIT signs, it will be appreciated that signs having other words, letters, indicia, or designs, may incorporate the techniques of the present invention.

Thus, while various embodiments of the present invention have been illustrated and described, it will be appreciated to those skilled in the art that many changes and modifications may be made thereunto without departing from the spirit and scope of the invention.

1. A photoluminescent EXIT sign comprising:
a generally planar rectangular metallic faceplate comprising a front surface, a rear surface, a length, and a width, said faceplate comprising a plurality of openings through said faceplate extending from said front surface to said rear surface defining the word “EXIT,” a periphery of said each of said openings comprising a metallic beveled surface extending between said front surface and said rear surface of said faceplate;
a colored layer disposed on said front surface of said faceplate;
a generally planar photoluminescent backplate comprising a front surface, and a rear surface;
said front surface of said backplate being disposed tightly against said rear surface of said faceplate so that the lowermost edges of said openings defining said word “EXIT” are disposed tightly against said front surface of said generally planar photoluminescent backplate; and
wherein said beveled surfaces along said peripheral edge of said openings defining the word “EXIT” are operable to reflect ambient light in lighted conditions and reflect luminescent light emitted from said photoluminescent backplate in dark conditions.

2. The photoluminescent EXIT sign of claim 1 wherein said periphery of each of said openings comprises said metallic beveled surface extending from said front surface to said rear surface of said faceplate, said colored layer abutting upper edges of said metallic beveled surface, and wherein said front surface of said backplate being disposed tightly against said rear surface of said faceplate so that the lowermost metallic beveled edges of said metallic beveled openings defining said word “EXIT” are disposed tightly against said front surface of said generally planar photoluminescent backplate.

3. The photoluminescent EXIT sign of claim 2 wherein an entire periphery of each of said openings comprises said metallic beveled surface extending from said front surface to said rear surface of said faceplate.

4. The photoluminescent EXIT sign of claim 3 wherein said faceplate comprises a thickness of about 1/16-inch.

5. The photoluminescent EXIT sign of claim 4 wherein said metallic beveled surface is disposed at an angle of about 45-degrees relative to the front surface of said faceplate.

6. The photoluminescent EXIT sign of claim 1 wherein said periphery of said each of said openings comprises said metallic beveled surface extending from said front surface to a middle portion of said faceplate and a normal surface extending from said beveled surface to said rear surface of said faceplate.

7. The photoluminescent EXIT sign of claim 6 wherein said entire periphery of said openings comprise said metallic beveled surface extending from said front surface to a middle portion of said faceplate and a normal surface extending from said beveled surface to said rear surface of said faceplate.

8. The photoluminescent EXIT sign of claim 7 wherein said faceplate comprises a thickness of about ⅛-inch, and said beveled surface comprises a thickness of 1/16-inch and said normal surface comprises a thickness of about 1/16-inch.

9. The photoluminescent EXIT sign of claim 8 wherein said metallic beveled surface is disposed at an angle of about 45-degrees relative to the front surface of said faceplate.

10. The photoluminescent EXIT sign of claim 1 wherein the faceplate comprises aluminum.

11. The photoluminescent EXIT sign of claim 10 wherein colored layer comprises a solid black color.

12. The photoluminescent EXIT sign of claim 11 wherein the photoluminescent backplate comprises a green color.

13. The photoluminescent EXIT sign of claim 10 wherein colored layer comprises a solid red color.

14. The photoluminescent EXIT sign of claim 13 wherein the photoluminescent backplate comprises a green color.

15. The photoluminescent EXIT sign of claim 1 wherein the photoluminescent backplate comprises a photoluminescent impregnated polymer sheet.

16. The photoluminescent EXIT sign of claim 1 wherein the photoluminescent backplate comprises a rear support layer and a front photoluminescent layer.

17. The photoluminescent EXIT sign of claim 1 wherein said photoluminescent material backplate comprises a luminance of at least 50 mcd/m2 at 60 minutes after exposure to 1000 lux xenon arc lamp for 5 minutes.

18. The photoluminescent EXIT sign of claim 1 wherein said faceplate further comprises at least one opening defining at least one directional chevron.

19. A method for forming a photoluminescent EXIT sign, the method comprising:
providing a generally planar rectangular metallic faceplate;
forming a plurality of openings defining the word “EXIT,” a periphery of said each of said openings comprising a metallic beveled surface extending between said front surface and said rear surface of said faceplate;
providing a backplate comprising a photoluminescent material; and
disposing the photoluminescent material of the backplate adjacent to the faceplate to result in illuminated letters defining the word “EXIT.”

20. The method of claim 19 wherein the forming a plurality of openings comprises forming the plurality of openings comprising the metallic beveled surface extending from said front surface to said rear surface of said faceplate.

21. The method of claim 20 wherein the forming a plurality of openings comprises forming an entire periphery of each of said openings having a beveled surface extending from said front surface to said rear surface of said faceplate.

22. The method of claim 21 wherein the faceplate comprises a thickness of about 1/16-inch.

23. The method of claim 19 wherein the forming a plurality of openings comprises forming the plurality of openings comprising the metallic beveled surface extending from said front surface to a middle portion of the faceplate and a normal surface extending from the beveled surface to the rear surface of the faceplate.

24. The method of claim 23 wherein the forming a plurality of openings comprises forming an entire periphery of each of said openings having the metallic beveled surface extending from said front surface to a middle portion of the faceplate and a normal surface extending from the beveled surface to the rear surface of the faceplate.

25. The method of claim 24 wherein the faceplate comprises a thickness of about ⅛-inch, and the beveled surface comprises a thickness of 1/16-inch and the normal surface comprises a thickness of about 1/16-inch.

26. The method of claim 19 further comprising coating the faceplate with an outer coating comprising a solid black color.

27. The method of claim 19 further comprising coating the faceplate with an outer coating comprising a solid red color.

28. The method of claim 19 wherein the photoluminescent material comprises the color green.

29. The method of claim 19 wherein the photoluminescent material backplate comprises a luminance of at least 50 mcd/m2 at 60 minutes after exposure to 1000 lux xenon arc lamp for 5 minutes.

30. The method of claim 19 wherein the faceplate further comprises forming at least one opening defining at least one directional chevron.
